(19) United States
(12) Patent Application Publication
(10) Pub. No.: US 2017/0130883 A1
(43) Pub. Date: May 11, 2017

(54) MODULAR PIPE SYSTEMS AND COMPONENTS

(71) Applicant: Arran (Aust) Pty Limited, New South Wales (AU)

(72) Inventor: John S. McNab, New South Wales (AU)

(21) Appl. No.: 15/321,104

(22) PCT Filed: Jun. 18, 2015
(86) PCT No.: PCT/AU2015/050336

§ 371 Date: Dec. 21, 2016

(30) Foreign Application Priority Data
Jun. 26, 2014 (AU) 2014902449
Feb. 3, 2015 (AU) 2015900325
Feb. 5, 2015 (AU) 2015900349

(51) Int. Cl. F16L 27/08; F16L 43/00; F16L 37/098; H02G 3/04; H02G 1/08

(52) U.S. Cl. CPC F16L 27/0841; H02G 3/0475; H02G 1/08; F16L 37/0985; F16L 43/008; F16L 43/001

(57) ABSTRACT

Pipework components are described including: a tubular body; the body includes first and second ends which include respective corresponding male and female attachment formations; the body defines an interior passageway extending from the first end to the second end; the first and second attachment formations are angled with respect to one another.

### TECHNICAL FIELD

The present invention relates to pipe systems including pipe for conveying pressurised or non-pressurised fluids and pipe used in conduit systems such as electrical, data cabling and cummincations conduit systems.

### BACKGROUND TO THE INVENTION

Pipes are used in many applications in construction, building and industrial installations. Pipe may carry pressurised or non-pressurised fluids in the form of liquids or gases.

In many jurisdictions, building regulations dictate that electrical wiring and other services must be enclosed by a protective conduit system. A conduit system typically comprises various lengths of pipe joined by junction boxes and connectors. The electrical wiring sits inside the conduit which protects the wiring from impact, moisture and chemical vapours and protects personnel from risk of electric shock.

Traditionally, pipes were formed from metals. More recently, plastics have been used such as PVC. The advantages of plastic are reduced cost, weight and improved ease of installation due to easier ability to cut the pipes to length.

It is often desirable to provide a bend in a pipework installation. In the case of providing a bend in electrical conduit, the radius of the bend is selected according to various factors including the flexibility of the conductors which will be housed in the conduit and also to improve the ease of pulling conductors through the conduit. A bend with a small radius will generally impede the passage of a conductor through the conduit making the job of pulling the conductor through difficult or impossible, and bringing the risk of damage to the conductor due to high forces required to pull the conductor through the conduit, whereas a bend with a larger radius will provide less resistance to pulling the conductor through.

Similarly, the diameter of a conduit which is to contain cables is selected to suit the ease of pulling the cables through the conduit which can be difficult in the case of large diameter cables. A larger diameter conduit generally offers less resistance to a pulled cable. The diameter is selected to prevent undue stress being placed on a cable during the pulling operation.

It is possible to provide a bend in a length of PVC pipe by applying heat to a length of straight PVC pipe to soften the pipe. The pipe can then be bent to the desired radius of bend and allowed to cool.

In some scenarios, other building regulations preclude the use of PVC pipes. For instance, in the case of installations in tunnels, there is an overriding requirement that materials used in construction meet applicable fire or smoke regulations. PVC will not usually satisfy these requirements. Metal conduits would be expected to meet fire regulations, but bring with them the associated increased cost, weight, and more time consuming and arduous installation process.

It is possible to use pipes in such applications that are made of a non-halogenated fire-retardant plastic which meet fire and electrical regulations. However, the thermal and mechanical properties of these plastics means that lengths of pipe formed from these plastics cannot be easily bent to form a bend. Furthermore, due to shape memory properties, even if a length of pipe is bent it can return to its original shape over time. The problems associated with bending pipes of these types become more pronounced in the case of larger diameter pipes.

### SUMMARY OF THE INVENTION

In a first aspect the present invention provides a pipework component, the component including a tubular body; the body includes first and second ends which include respective corresponding male and female attachment formations; the body defines an interior passageway extending from the first end to the second end; the first and second attachment formations are angled with respect to one another.

Optionally, the interior passageway is curved.

Optionally, the male and female attachment formations are arranged to snap fit to a corresponding male or female attachment formation.

Optionally, the male and female attachment formations are arranged to attach a corresponding male or female attachment formation to form a fluid tight connection.

Optionally, the component is formed from a fire retardant plastic material.

In a second aspect the present invention provides a kit of parts for use in constructing pipework including: a number of components according to the first aspect of the invention.

Optionally, the kit of parts further includes at least one end socket which is arranged to join a pipework component to a length of pipe.

In a third aspect the present invention provides a pipe assembly including a number of components according to the first aspect of the invention which are joined end to end.

Optionally, the pipe assembly further includes at least one end socket which is arranged to join the assembly to a length of pipe.

In a fourth aspect the present invention provides a method of forming a pipework component according to the first aspect of the invention including the step of forming the component by way of a three dimensional printing technique.

In a fifth aspect the present invention provides a method of installing a cable in a bend in a conduit system including the steps of: providing a number of pipework components according to the first aspect of the invention; threading the cable through the internal passageway of the components; joining the first and second ends of adjacent components by way of their respective corresponding male and female attachment formations.

The method may further include the step of providing at least one end socket; threading the cable through the internal passageway of the end socket; joining the end socket to one of the components; and joining the end socket to a length of conduit.

### BRIEF DESCRIPTION OF THE DRAWINGS

An embodiment of the present invention will now be described, by way of example only, with reference to the accompanying drawings, in which:

FIG. 1 is a perspective view of a pipework component according to an embodiment of the invention;

FIG. 2 is a cross sectional view of the pipework component of FIG. 1;

FIG. 3 is a perspective view of a male-type end socket that can be assembled with the pipework component of FIG. 1;

FIG. 4 is a cross sectional view of the end socket of FIG. 3;

FIG. 5 is a perspective view of a female-type end socket that can be assembled with the pipework component of FIG. 1;

FIG. 6 is a cross sectional view of the end socket of FIG. 5;

FIG. 7 is a front view of a pipe bend assembly incorporating the components shown in FIGS. 1, 3 and 5;

FIG. 8 is a side view of the assembly of FIG. 7;

FIG. 9 is a cross section view of the assembly of FIG. 7;

FIGS. 10 and 11 show alternative pipe assemblies incorporating the components of FIGS. 1, 3 and 5; and

FIGS. 12 to 14 illustrate steps in a method of installing a cable in a conduit.

### DETAILED DESCRIPTION OF THE PREFERRED EMBODIMENT

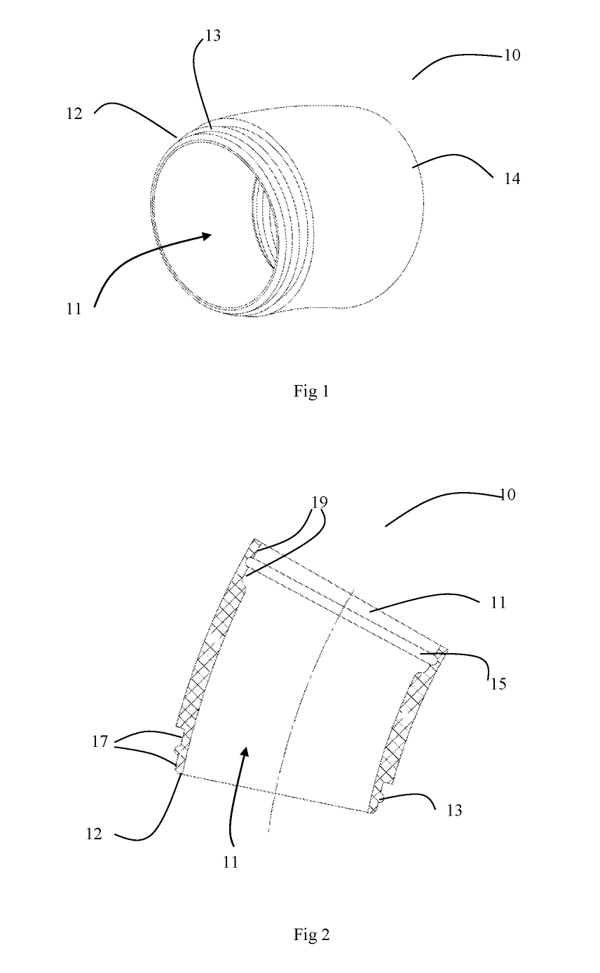

Referring to FIGS. 1 and 2, a pipework component is shown in the form of segment 10 which has a tubular body with an internal passageway extending between first and second ends of the body which terminate in male 12 and female 14 attachment formations. The male 12 and female 14 attachment formations correspond with one another so that segments 10 may be fitted together with the male attachment formation of one segment fitting to the female attachment formation of an adjacent segment.

Male attachment formation 12 includes a circumferential ridge 13 which stands proud of generally cylindrical surface 17. Female attachment formation includes a circumferential groove 15 in generally cylindrical surface 19. The ridge 13 and groove 15 are dimensioned so that segments can be snap fitted together with ridge 13 lying in groove 15 and with surfaces 17, 19 in contact with one another.

The body and internal passageway are curved with a constant radius. This results in the male 12 and female 14 attachment formations being angled with respect to one another. In the embodiment shown in FIG. 1 they are angled with respect to one another by 15 degrees.

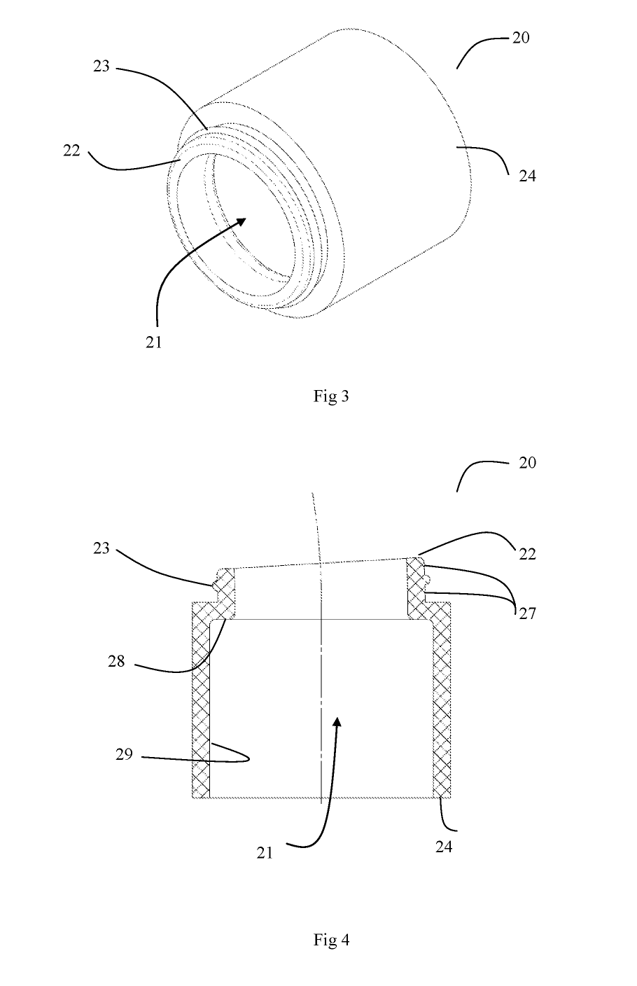

Referring to FIGS. 3 and 4, a male-type end socket 20 is shown. The end socket 20 has a tubular body with an internal passageway 21 extending between first and second ends of the body. A male attachment formation 22 is provided at one end of the body. A socket formation 24 is provided at the other end. The male attachment formation 22 is of the same shape as the male attachment formation 12 of the segment shown in FIG. 1 and includes a circumferential ridge 23 which stands proud of a generally cylindrical surface 27. The male attachment formation 22 is dimensioned to snap fit to the female attachment formation 14 of the segment of FIG. 1.

The socket formation 24 is dimensioned to fit to a length of pipe (not shown) with an internal diameter of a similar size to the internal diameter of segment 10. The pipe end is inserted into the end socket 20 to abut against shoulder 28 with the inside surface 29 lying against the outer surface of the pipe. The pipe may be fixed to the end socket 20 with an adhesive.

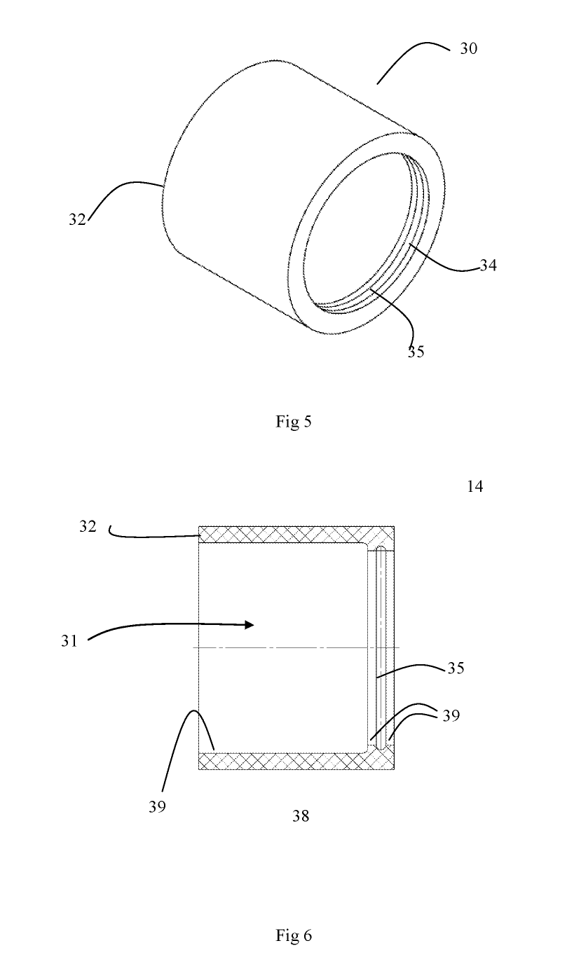

Referring to FIGS. 5 and 6, a female-type end socket 30 is shown. The end socket 30 has a tubular body with an internal passageway 31 extending between first and second ends of the body. A female attachment formation 34 is provided at one end of the body. A socket formation 32 is provided at the other end. The female attachment formation 34 is of the same shape as the female attachment formation 14 of the segment shown in FIG. 1 and includes a circumferential groove 35 in generally cylindrical surface 39. The female attachment formation 34 is dimensioned to snap fit to the male attachment formation 12 of the segment of FIG. 1.

The socket formation 32 is identical to the socket formation 24 of end socket 20.

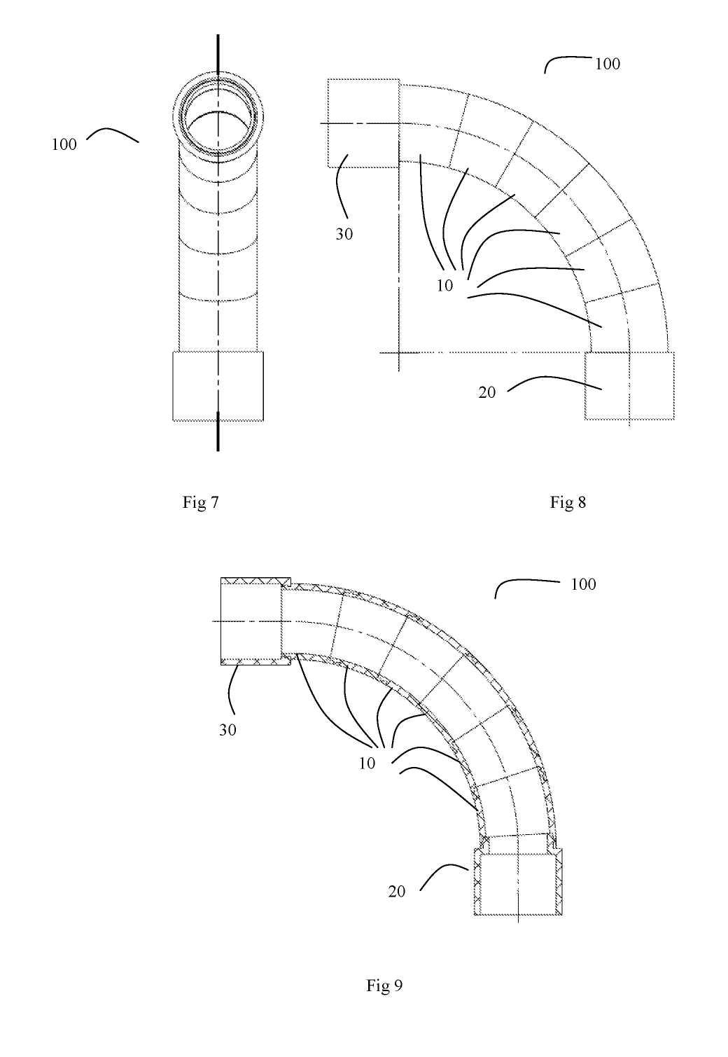

Referring to FIGS. 7, 8 and 9 a pipe assembly 100 is shown including one female-type end socket 30, six segments 10 and one male-type end socket 20, all of which are snap fitted together by way of their respective male and female attachment formations. The internal passageways of all of the components cooperate to create a passageway extending from the female-type end socket 30 to the male-type and socket 20. By using six of segments 10, each of which provide a bend of 15 degrees, the entire assembly forms a 90 degree bend. The assembly 100 may be joined to lengths of pipe by way of attaching lengths of pipe to the end sockets 20, 30.

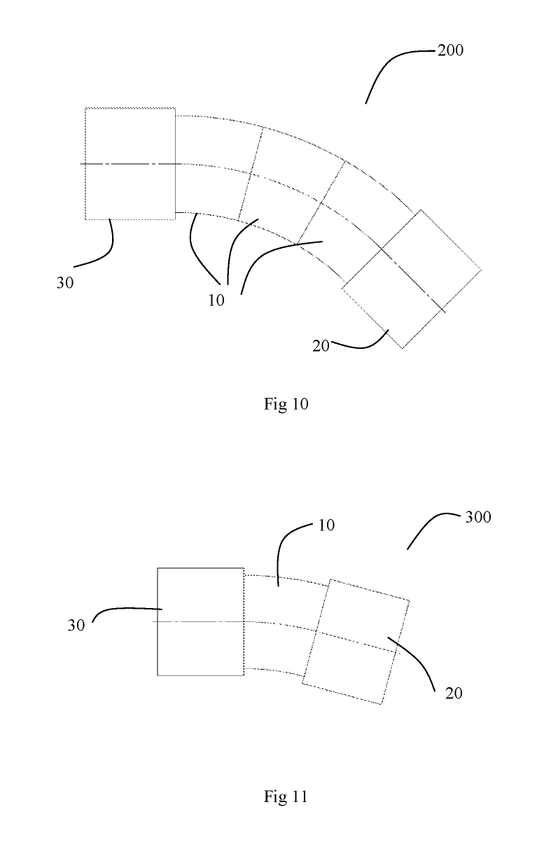

Referring to FIG. 10, an assembly 200 is shown utilising three segments 10. The assembly provides a combined bend of 45 degrees.

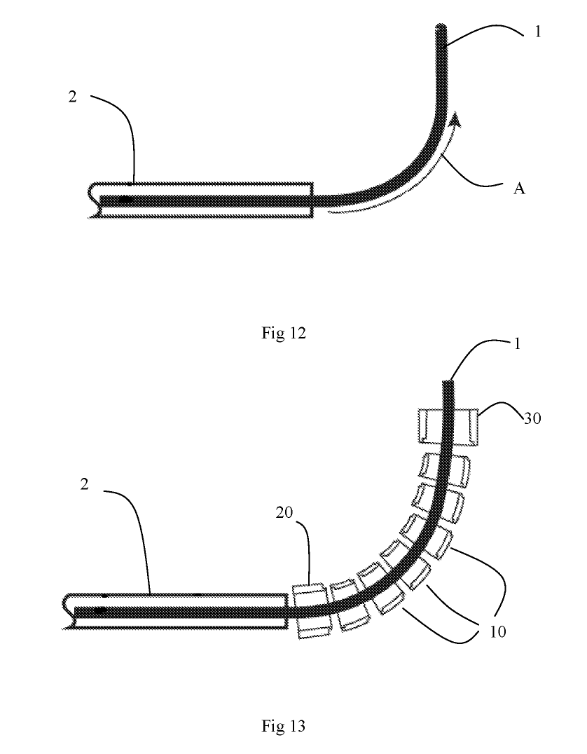

Referring to FIG. 11, an assembly 300 is shown utilising one segment 10. The assembly provides a bend of 15 degrees.

It is possible to join adjacent segments 10 at various rotational angular orientations to produce complex bends. In some embodiments, the attachment formations may be keyed to ensure they are assembled together in a predetermined angular orientation, and to prevent relative rotation of adjacent segments once assembled.

A method of installing a cable in a conduit will now be described with reference to FIGS. 12 to 14. The method involves constructing the conduit around the cable as it is laid instead of first assembling the conduit and later pulling the cable through.

Referring to FIG. 12, the conduit has been partially installed. A cable has been inserted into a straight section of conduit 2. It is desired to provide a 90 degree bend in the cable and conduit in the region indicated by arrow A. The cable 1 is bent to approximately the desired shape.

Referring to FIG. 13, a series of components are threaded onto the free end of cable 1 in sequence being a male-type end socket 20, six segments 10 and a female-type end socket 30.

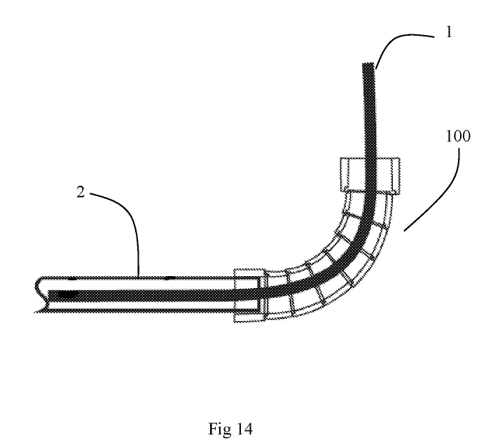

Referring to FIG. 14, the male-type end socket 20, segments 10 and female-type end socket 30 have been joined together to provide an assembly 100 having 90 degree bend. The assembly has been joined to the free end of straight conduit 2. The installation will now proceed by threading a further straight section of conduit onto the free end of cable 1 which will be joined to the free end of assembly 100. Additional bends and straight sections are added until the conduit system is completed, each being threaded in sequence onto to the free end of cable 1.

This method avoids the need to pull the cable through a previously fabricated conduit system. Bends of different angles can be provided by utilising differing numbers of segments 10. In the embodiment described above each segment provided a bend of 15 degrees. On other embodiments the segments may provide greater or lesser degrees of bend.

In the embodiment described above all of the components are formed from a non-halogenated fire retardant material. The components are advantageously formed by a three dimensional printing process such as a process that forms the component by building up layers of material. Use of three dimensional printing techniques allows small batch runs of components. Furthermore, it allows for components to be produced that are scaled up or down in size to suit a range of pipe diameters and installations.

In other embodiments, the components may be formed by injection moulding or other fabrication techniques.

In other embodiments the components may be formed from either metallic or non metallic materials. Suitable non-metallic materials including Polyamide. Polyethylene, Polybutylene, Polypropylene, ABS, HIPS, PPO, PET, TPE, PEK, Polycarbonate, PVC, PEEK, Polyurethane, and any combination or compound of thermoplastic or thermoset plastics. Suitable metallic materials include steel, aluminium, brass, bronze, copper and or any combination of metallic compounds.

Embodiments of the invention are suitable for use as electrical conduit or for pressure or non-pressure pipe for conveying fluids.

In some embodiments, a sealing arrangement may be provided at the joins between the components such as 0-rings.

In some embodiments the components are held together by set screws or by welded joints. In some embodiments the components are held together by way of a twist lock, screw threaded fitting or by way of adhesive. The manner in which the components are held together can me selected according to the particular material from which the components are made.

In this specification, the term “pipe” is intended to cover both pressure and non-pressure pipe as well as conduit.

It can be seen that embodiments of the invention have at least one of the following advantages:
Pipe bends can be constructed using fire-retardant plastic materials to satisfy fire regulations
Pipe bends of various angles can be created using modular components
Components can be rapidly produced that are scaled up or down in size
A conduit and cable can be installed by assembling bends in the conduit around the cable. This avoids the need for pulling the cable through a completed conduit which can put undue stress on the cable. This allows for the specification of a conduit of a smaller diameter than would be required if a cable were to be pulled through a completed conduit, thus saving on the cost of materials.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A pipework component, the component including:
a tubular body;
the body includes first and second ends which include respective corresponding male and female attachment formations;
the body defines an interior passageway extending from the first end to the second end;
the first and second attachment formations are angled with respect to one another.

2. A pipework component according to claim 1 wherein the interior passageway is curved.

3. A pipework component according to claim 1 wherein the male and female attachment formations are arranged to be fastened to a corresponding male or female attachment formation by way of a snap fit.

4. A pipework component according to claim 1, wherein the male and female attachment formations are arranged to attach a corresponding male or female attachment formation to form a fluid tight connection.

5. A pipework component according to claim 1, which is formed from a fire retardant plastic material.

6. A kit of parts for use in constructing pipework including:
a plurality of pipework components according to claim 1.

7. A kit of parts according to claim 6 further including at least one end socket which is arranged to join a pipework component to a length of pipe.

8. A pipe assembly including:
a plurality of pipework components according to claim which are joined end to end.

9. A pipe assembly according to claim 8 further including at least one end socket which is arranged to join the assembly to a length of pipe.

10. A method of forming a pipework component according to claim 1 including the step of:
forming the component by way of a three dimensional printing technique.

11. A method of installing a cable in a bend in a conduit system including the steps of:
providing a number of pipework components according to claim 1;
threading the cable through the internal passageway of the components;
joining the first and second ends of adjacent components by way of their respective corresponding male and female attachment formations.

12. A method according to claim 11 further including the step of providing at least one end socket;
threading the cable through the internal passageway of the end socket;
joining the end socket to one of the components; and
joining the end socket to a length of conduit.
